(19) United States
(12) Patent Application Publication
(10) Pub. No.: US 2017/0093801 A1
(43) Pub. Date: Mar. 30, 2017

(54) Secure content distribution

(71) Applicant: Mark Ellery Ogram, Tucson, AZ (US)

(72) Inventor: Mark Ellery Ogram, Tucson, AZ (US)

(21) Appl. No.: 14/756,678

(22) Filed: Sep. 29, 2015

(51) Int. Cl. H04L 29/06; H04W 12/02

(52) U.S. Cl. CPC H04L 63/0428; H04W 12/02; H04W 88/02

(57) ABSTRACT

The invention provides a content distribution system having a central computer having a memory having stored therein digital content, together with a receiving mechanism such a laptop, cellular phone, tablet, or the like. Using a unique identifier from a component in the receiving mechanism, the digital content is encrypted and communicated to the receiving mechanism which alone is able to decrypt the encrypted digital content.

### BACKGROUND OF THE INVENTION

This invention relates generally to encryption and more particularly to site specific encryption.

The Internet has provided a vast amount of freedom of access to a wide range of information. A user is able to search for information that heretofore would have taken days or even weeks to find through more traditional ways.

Additionally the Internet has allowed users to share information with acquaintances in an unfettered manner. Going past social media, personal photos, personal stories, content personal to the user are easily and freely shared with others; but, this freedom has run up against content that is proprietary to third parties. Movies, songs, books, business plans, spread sheets, mechanical drawings, customer lists and a host of other proprietary information is all too often “shared” with others who don't have the right to the proprietary information.

Whereas, before the Internet, a book could be sold to an individual with the generally secure knowledge that only this single copy was being sold; now with the Internet, the electronic book is easily and without any tracking information, shared with countless others. This freedom of sharing has eliminated the financial gains that authors are entitled to receive.

This has forced those with proprietary information to avoid making it accessible on the Internet. This self-censure though has hampered the proper distribution of the proprietary information.

It is clear there is a need to assure that material delivered to a specific site is not capable of being garnered or shared with third parties.

### SUMMARY OF THE INVENTION

The present invention creates a content distribution system which maintains the integrity of the content while allowing only the authorized user to obtain access to it and prevents unauthorized users from viewing the content.

In this discussion, digital content is any digital material including, but not limited to: books, essays, news articles, movies, movie shorts, music, advertisements, spread sheets, business plans, computer programs, classified information, logos, and may others that those of ordinary skill in the art readily recognize.

In this regards, the content distribution system uses two major components: a central computer having a memory having stored therein the digital content, and a receiving mechanism/apparatus. In this context, the receiving mechanism is any of a variety of apparatus including: personal computers, laptop computers, computer pads, smart phones, smart watches, and the like. Those of ordinary skill in the art readily recognize a variety of other such instruments.

Those of ordinary skill in the art readily recognize a variety of computers which can be used in this context, including, but not limited to those described in: U.S. Pat. No. 9,021,408, entitled “System, Method, and Computer Program Product for Translating a Source Database into a Common Hardware Database” issued to Alfieri on Apr. 28, 2015; U.S. Pat. No. 9,104,494, entitled “Virtual Computer System and its Optimization Method” issued to Kami on Aug. 11, 2015; and U.S. Pat. No. 9,128,516, entitled “Computer-Generated Imagery using Hierarchical Models and Rigging” issued to Green on Sep. 8, 2015; all of which are incorporated hereinto by reference.

Also, those of ordinary skill in the art readily recognize a variety of cellular telephone designs which can be used in this context, including, but not limited to: U.S. Pat. No. 7,937,117, entitled “Portable Speakerphone with Pivoting Microphone Boom” issued to Dyer on May 3, 2011; and, U.S. Pat. No. 5,289,526, entitled “Cellular System Access Monitor” issued to Chymyck et al. on Feb. 22, 1994; and, U.S. Pat. No. 9,125,128, entitled “Telephone with Automatic Switching Between Cellular and VoIP Networks” issued to Ganesan on Sep. 1, 2015; all of which are incorporated hereinto by reference.

The receiving mechanism accesses one or more of its own components to obtain a unique identifier therefrom. This identifier uniquely identifies the component and is a serial number type of identifier. Those of ordinary skill in the art readily recognize a variety of components that can be used in this context, including, but not limited to: hard drive; CPU, etc. In the preferred embodiment, the unique identifier is pulled from a single component, although in some embodiments, the identifiers from two or more components are used to create the unique identifier that will be used in this invention.

This unique identifier is communicated to the central computer for later use. The central computer sends the receiving mechanism a “generic” decryption program. That is, the decryption program is the same for every receiving mechanism in the distributed system. The order of information communication is not important as the unique identifier is optionally sent either before or after the communication of the generic description program.

Those of ordinary skill in the art readily recognize a variety of encryption techniques which are applicable in this context, including, but not limited to: U.S. Pat. No. 7,852,240, entitled “Variable Length Encryption” issued to Ogram on Dec. 14, 2010; and, U.S. Pat. No. 7,792,289, entitled “Encrypted Communications” issued to Ogram on Sep. 7, 2010; both of which are incorporated hereinto by reference.

For the distribution stage of the process, which may be at the same time as the communication of the generic decryption program or may not be done for several days, months, or even years, the central computer (in transferring the content to a specific receiving mechanism) utilizes the unique identifier from the receiving mechanism together with an encryption algorithm to form an encrypted digital content unique for the receiving mechanism. This unique encrypted digital content is then communicated to the receiving mechanism using any manner of distribution channels or mechanisms including, but not limited to: the Internet, distributed networks, telephone systems, cellular systems, or an Intranet.

When the user of the receiving mechanism is ready to view the unique encrypted digital content, the user activates the generic decryption program. The generic decryption program accesses the identifier of the component(s) within the receiving mechanism to perform the decryption of the unique encrypted digital content into “clear text”; thereby allowing the user of the targeted receiving mechanism to read the “clear text”.

If though the unique encrypted digital content is somehow obtained by an interloper's computer, when the interloper attempts to obtain the “clear text” using a copy of the generic decryption program, the decryption will not produce “clear text” since the unique identifier for the interloper's computer is different than the unique identifier used by the central computer to originally encrypt the digital content.

The preferred embodiment of the invention uses a unique identifier from a single component within the receiving mechanism (a memory apparatus such as a hard drive in the preferred embodiment or the Central Processing Unit “CPU”); but the invention is not so limited. In some embodiments, the unique identifier is an alpha/numeric sequence or combination of several components; in other embodiments the unique identifier is created using pieces or individual values placed in a pre-arranged order.

The preferred embodiment utilizes a computer as the receiving mechanism. In other embodiments, the receiving mechanism is a cellular telephone, tablet, or other such apparatus.

While the above description of the invention employs only the unique identifier for the decryption process; another embodiment of the invention further uses a Personal Identifier Number (PIN) from the authorized user as well. This PIN has previously been communicated to the central computer which uses the PIN in conjunction with the unique identifier in the encryption process.

The use of a PIN, which doesn't appear anywhere on the receiving mechanism, adds another layer of security to the system and prevents a thief from stealing the receiving mechanism to get at the digital content because the thief does not know the PIN of the authorized user.

The invention together with various embodiments will be more fully explained by the accompanying drawings and the following descriptions thereof.

### DRAWINGS IN BRIEF

FIG. 1 graphically illustrates the communication channels between the devices.

FIG. 2A is a flow chart of the operation of the content computer in communicating the generic decryption algorithm.

FIG. 2B is a flow chart of the operation of the receiving mechanism in obtaining the generic decryption algorithm.

FIG. 3A is a flow chart illustrating the distribution of encrypted content by the content computer.

FIG. 3B is a flow chart illustrating the receipt of the encrypted content by the receiving mechanism.

FIG. 4 graphically illustrates the movement of the decryption process on an encrypted content in memory.

FIG. 5 is a flow chart of the operation of the receiving mechanism in displaying the encrypted content in clear text.

### DRAWINGS IN DETAIL

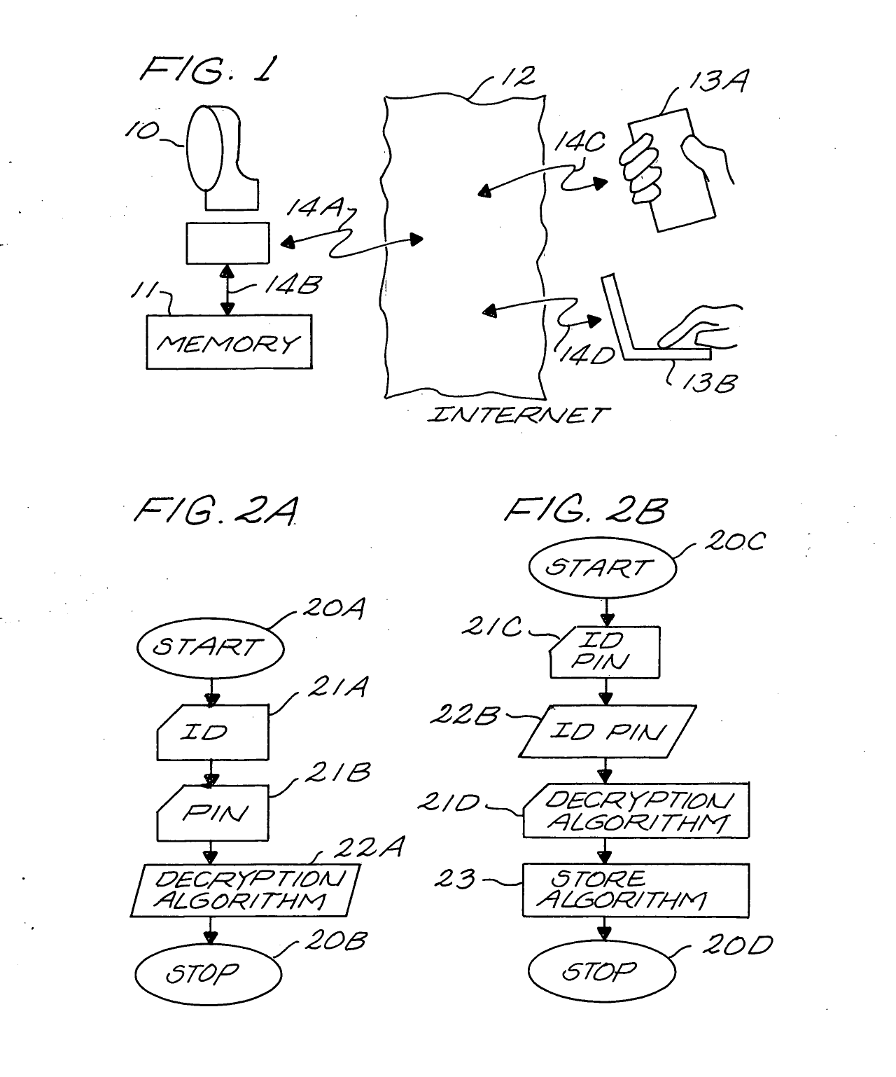

FIG. 1 graphically illustrates the communication channels between the devices.

Central computer 10 is connected, in this embodiment, to a remote memory 11 containing the digital content. In the preferred embodiment, the digital content within memory 11 is encrypted as described above, so that the digital content can only be read by central computer 10. When a request, via Internet 12, as communicated by link 14A, for a specific content, central computer 10 retrieves the chosen digital content from memory 11 and then decrypts the encrypted digital content into clear text.

Central computer 10 identifies who has made the request for the digital content, say cellular telephone 13A, which has interacted with the Internet 12 via link 14C, using this information, and drawing on the stored user's information in memory 11, central computer 10 encrypts the digital content specifically for cellular telephone 13A. This specifically encrypted digital content is communicated via link 14A, Internet 12, and link 14C to cellular telephone 13A.

In this illustration, the Internet is used as the communication mechanism, but other such communication mechanisms are also available and are obvious to those of ordinary skill in the art including telephone/cellular systems and intranets.

In like fashion, lap top 13B is able to request, via link 14D, digital content from central computer 10. Lap top 13B receives encrypted digital content that is specifically encrypted for laptop 13B.

If laptop 13B were able to purloin the encrypted digital content originally destined for cellular telephone 13A, the material would be useless as laptop 13B is unable to decrypt the encrypted digital content which has been specifically encrypted for cellular telephone 13A

FIG. 2A is a flow chart of the operation of the content computer in communicating the generic decryption algorithm. FIG. 2B works in conjunction with FIG. 2A.

As shown in FIG. 2A, the program within central computer starts 20A and the unique identifier from the receiving mechanism is obtained 21A as well as the operator defined Personal Identifier Number (PIN) 21B. The unique identifier and PIN are stored within the memory of the central computer for later use.

The generic (or blank) decryption algorithm is communicated 22A to the receiving mechanism. This generic algorithm is essentially blank is totally inoperable without the Unique identifier found on the receiving mechanism as well as the PIN from the user.

Note, the position of input 21 and input 21B within the flow chart of FIG. 2A is optionally reversed without affecting the intent of this invention.

In some embodiments, no PIN is required from the user allowing the receiving mechanism to work without any input from the user of the receiving mechanism. Although this embodiment creates an easy to use mechanism, it is not as secure as anyone who has access to the receiving mechanism is able to decrypt the encrypted digital content which the receiving mechanism has access to.

This gives decryption algorithm is then communicated to the receiving mechanism (FIG. 2B). In an alternative embodiment, the operation 22A occurs before element 21A in the flow chart of operations

The program then stops 20B.

On the other side, as shown in FIG. 2B, a flow chart of the operation of the receiving mechanism is shown. This flow chart illustrates how the receiving mechanism signs up and obtains the generic decryption algorithm.

The program on the receiving mechanism starts 20C and obtains the unique identifier from a component within the receiving mechanism and the PIN from the user 21C. The Unique Identifier and the PIN are then communicated to the central computer (as discussed above). The receiving mechanism receives the generic decryption algorithm 21D and stores the generic algorithm 23 in the memory of the receiving mechanism.

Note, in this embodiment, every receiving mechanism, within the network, has an identical decryption algorithm as the decryption algorithm is inoperable without the unique identifier found within the receiving mechanism and the PIN provided by the user.

The program then stops 20D.

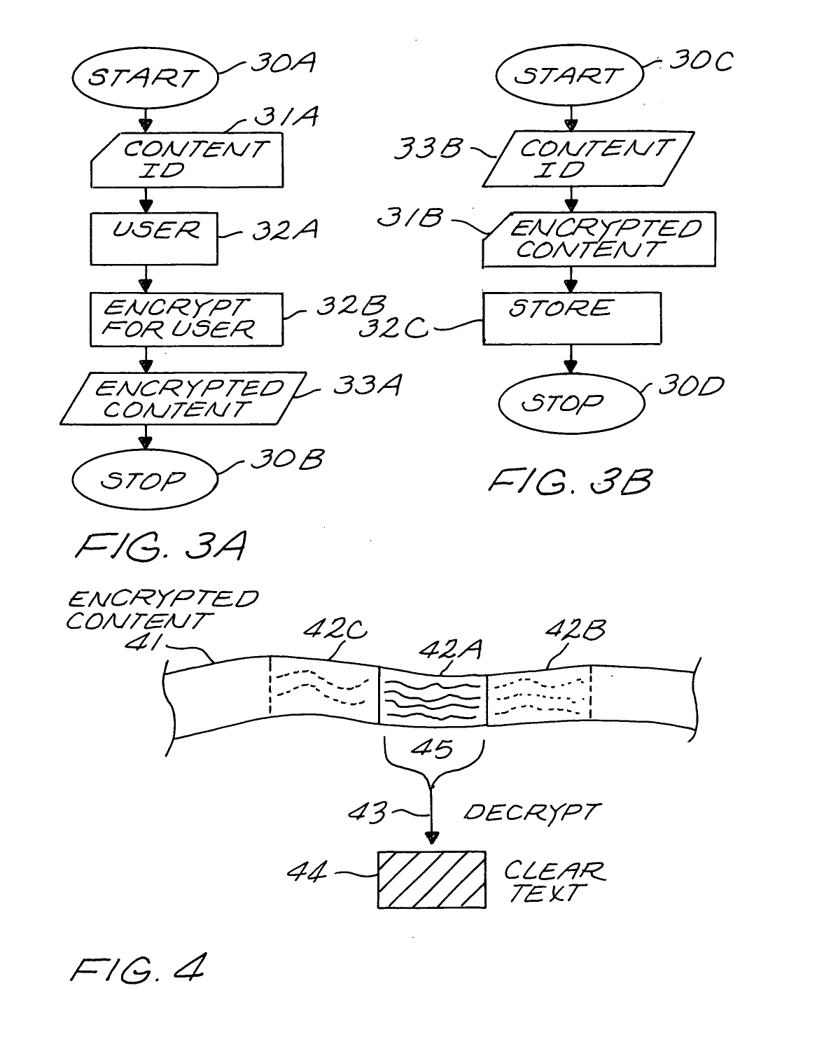

FIG. 3A is a flow chart illustrating the distribution of encrypted content by the central computer.

Upon activation (start) 30A, the program receives an identification of the content which is sought 31A. The content is encrypted 32B for the specific receiving mechanism and the encrypted content is communicated 33A. The program then stops 30B.

FIG. 3B is a flow chart illustrating the receipt of the encrypted content by the receiving mechanism.

The program starts 30C and the identification of the specific content sought (as identified by the user of the receiving mechanism) is communicated to the central computer 33B. The receiving mechanism receives the encrypted content 31B (which has been encrypted as outlined in FIG. 3A). The encrypted content is stored 32C and the program stops 30D.

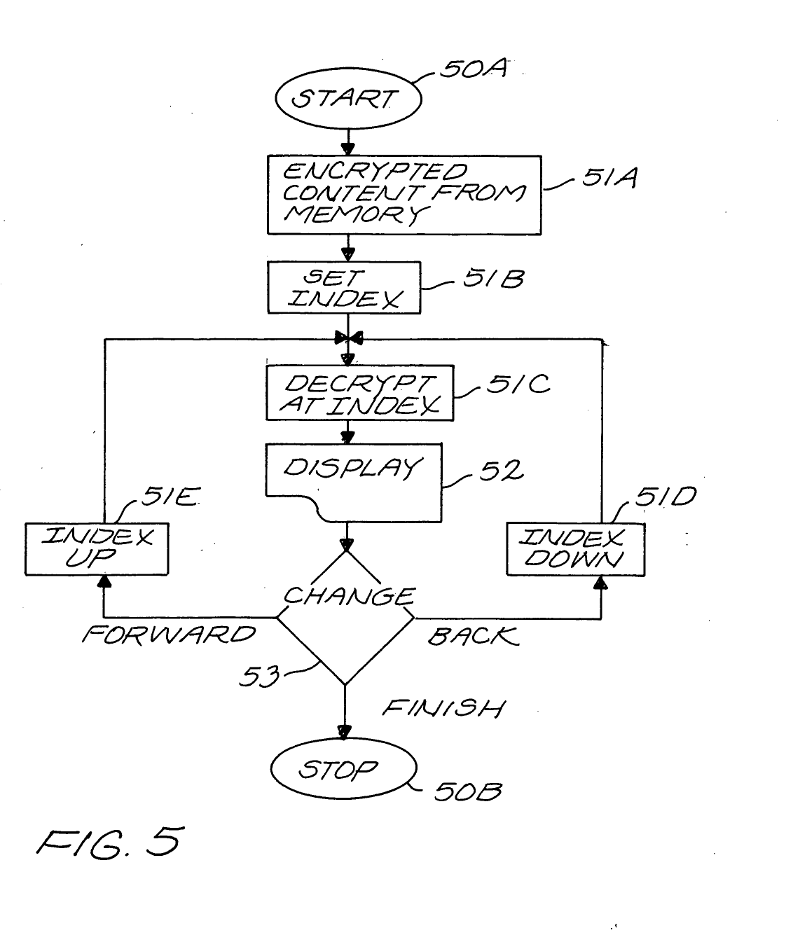

FIG. 4 graphically illustrates the movement of the decryption process on an encrypted content in memory.

Encrypted content 41 is composed of a series of “pages” or “sections”, such as segment 42A associated with pointer 45, which is decrypted 43 into clear text 44 and displayed. Note, only the page associated with the pointer 45 is ever in clear text.

Should the user want to see/read the next page, an input moves the pointer to the next page 42B, pointer 45 is moved to be associated with page 42B, page 42B is then decrypted and displayed in clear text, removing the prior clear text portion.

In like fashion, the prior page 42C is also available by moving pointer 45 appropriately.

FIG. 5 is a flow chart of the operation of the receiving mechanism in displaying the encrypted content in clear text.

In reading the content, the receiving mechanism starts 50A and pulls the encrypted content from memory 51A. The index/pointer 51B is set (initially at page 1, then later for the last page at least partially read). The page associated with the index/pointer is decrypted 51C and displayed in clear text 52.

The user/reader is able to select 53 to go forward to the next page, back to the prior page, or to finish reading. If the next page (forward) is selected, the index is incremented up 51E and the page associated with the new index is decrypted 51C and the process repeats. In like fashion, if the user/reader wants to go back to the prior page, the index is incremented downward 51D and the page associated with that index is then decrypted 51C and displayed 52.

Should the user/reader choose finish 53, then the program stops 50B.

Note, only a single page is ever in clear text, thereby preventing the user from copying the entire content in clear text and communicating the whole of the content to anyone else.

It is clear that the present invention provides protection for content, whether video, text, or executable software, delivered to a specific location is not capable of being garnered, stolen, corrupted, or shared with third parties.

What is claimed is:

1. A content distribution system comprising:
a) a central computer having a memory having stored therein digital content;
b) a receiving mechanism; and
c) wherein,
1) said central computer communicates a decryption algorithm to the receiving mechanism,
2) said receiving mechanism communicates a unique indicia from a component within said receiving mechanism to the central computer,
3) said central computer, using an encryption algorithm and said unique indicia, encrypts the digital content,
4) said central computer communicates the encrypted digital content to the receiving mechanism, and,
5) said receiving mechanism, using the decryption algorithm and the unique indicia, decrypts the encrypted digital content.

2. The content distribution system according to claim 1, wherein the unique indicia is drawn from a single component within said receiving mechanism.

3. The content distribution system according to claim 2, wherein the single component is a memory apparatus.

4. The content distribution system according to claim 3, wherein the memory apparatus is a hard disc memory.

5. The content distribution system according to claim 2, wherein the single component is a central processing unit.

6. The content distribution system according to claim 1, wherein the unique indicia is a combination of indices drawn from at least two components within said receiving mechanism.

7. The content distribution system according to claim 2, wherein said receiving mechanism is a computer.

8. The content distribution system according to claim 2, wherein said receiving mechanism is a cellular telephone.

9. The content distribution system according to claim 2, wherein the decryption algorithm additionally employs a receiving mechanism user generated indicia.

10. The content distribution system according to claim 2, wherein the decryption algorithm, responsive to a preselected operator input, deletes the encrypted digital content from the receiving mechanism.

11. A secure content decryption system for a computer having an encrypted digital content within a memory of the computer comprising:
a) a computer having a memory contained containing an encrypted digital content;
b) a display mechanism; and,
c) a decryption algorithm using a unique indicia from a physical component within the computer, decrypts the encrypted digital content and displays the decrypted content on the display mechanism.

12. The secure content decryption system for a computer according to claim 11, wherein the unique indicia is drawn from a single component which identifies the single component within said computer.

13. The content distribution system according to claim 12, wherein the single component is a central processing unit.

14. The secure content decryption system for a computer according to claim 13, wherein the decryption algorithm additionally employs a user generated indicia.

15. The secure content decryption system for a computer according to claim 14, wherein the decryption algorithm, responsive to a preselected operator input, deletes the encrypted digital content from the computer.

16. A secure content distribution computer comprising:
a) a distribution computer having a memory having stored therein digital content;
b) a communication mechanism; and
c) wherein,
1) said distribution computer receives, via the communication mechanism, a unique component indicia identifies a component within a remote apparatus,
2) said central computer, using an encryption algorithm and said unique indicia, encrypts the digital content from the memory, and,
3) said central computer communicates the encrypted digital content to the remote apparatus.

17. The secure content distribution computer according to claim 16, wherein the encryption algorithm further includes a user generated indicia of the remote apparatus.
